(19) United States
(12) Patent Application Publication
(10) Pub. No.: US 2024/0387085 A1
(43) Pub. Date: Nov. 21, 2024

(54) TRANSFORMER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: TAKASHI YAMADA, Nisshin-shi (JP)

(21) Appl. No.: 18/631,670

(22) Filed: Apr. 10, 2024

(30) Foreign Application Priority Data
May 15, 2023 (JP) 2023-080013

(51) Int. Cl. H01F 5/00; H01F 27/28; H01F 27/32; H01F 27/34

(52) U.S. Cl. CPC H01F 5/003; H01F 27/323; H01F 27/346; H01F 2027/2809

(57) ABSTRACT

A transformer includes a printed circuit board and a core. The printed circuit board includes wiring layers and an insulating layer sandwiched between the adjacent wiring layers. The core penetrates the printed circuit board. Each of the wiring layers includes a first winding pattern and a second winding pattern arranged to surround the core, and the first winding pattern and the second winding pattern in each of the wiring layers are insulated from each other. The first winding patterns of the adjacent wiring layers are connected by a first via in the insulating layer, and the first winding patterns of the wiring layers are connected in series to constitute a first coil. The second winding patterns of the adjacent wiring layers are connected by a second via in the insulating layer, and the second winding patterns of the wiring layers are connected in series to constitute a second coil.

### CROSS REFERENCE TO RELATED APPLICATION

The present application claims the benefit of priority from Japanese Patent Application No. 2023-080013 filed on May 15, 2023. The entire disclosure of the above application is incorporated herein by reference.

### TECHNICAL FIELD

The present disclosure relates to a transformer.

### BACKGROUND

There has been known a transformer that uses a wiring pattern of a printed circuit board.

### SUMMARY

The present disclosure provides a transformer including a printed circuit board and a core. The printed circuit board includes wiring layers stacked in a stacking direction and an insulating layer sandwiched between adjacent wiring layers in the wiring layers. The core penetrates the printed circuit board. Each of the wiring layers includes a first winding pattern and a second winding pattern arranged to surround the core, and the first winding pattern and the second winding pattern in each of the wiring layers are insulated from each other. The first winding patterns of the adjacent wiring layers are connected by a first via disposed in the insulating layer, and the first winding patterns of the wiring layers are connected in series to constitute a first coil that surrounds the core. The second winding patterns of the adjacent wiring layers are connected by a second via disposed in the insulating layer, and the second winding patterns of the wiring layers are connected in series to constitute a second coil that surrounds the core.

### BRIEF DESCRIPTION OF DRAWINGS

Objects, features and advantages of the present disclosure will become apparent from the following detailed description made with reference to the accompanying drawings. In the drawings:

FIG. 1 is a perspective view of a transformer according to a first embodiment;

FIG. 2 is an exploded perspective view of the transformer according to the first embodiment;

FIG. 3A is a plan view of a first wiring layer in a printed circuit board;

FIG. 3B is a plan view of a first insulating layer in the printed circuit board;

FIG. 3C is a plan view of a second wiring layer in the printed circuit board;

FIG. 3D is a plan view of a second insulating layer in the printed circuit board;

FIG. 3E is a plan view of a third wiring layer in the printed circuit board;

FIG. 3F is a plan view of a third insulating layer in the printed circuit board;

FIG. 3G is a plan view of a fourth insulating layer in the printed circuit board;

FIG. 4 is a cross-sectional view of the transformer taken along line IV-IV in FIG. 3A;

FIG. 5 is a cross-sectional view of a transformer according to a second embodiment;

FIG. 6A is a plan view of a first wiring layer in a transformer according to a third embodiment;

FIG. 6B is a plan view of a second wiring layer in the transformer according to the third embodiment;

FIG. 6C is a plan view of a third wiring layer in the transformer according to the third embodiment;

FIG. 7 is a circuit diagram of a transformer according to the third embodiment;

FIG. 8A is a plan view of a first wiring layer in a transformer according to a fourth embodiment;

FIG. 8B is a plan view of a second wiring layer in the transformer according to the fourth embodiment;

FIG. 8C is a plan view of a third wiring layer in the transformer according to the fourth embodiment;

FIG. 9 is a circuit diagram of the transformer according to the fourth embodiment; and

FIG. 10A is diagram illustrating a process of manufacturing a printed circuit board of a transformer according to another embodiment;

FIG. 10B is diagram illustrating a process of manufacturing the printed circuit board subsequent to the process illustrated in FIG. 10A;

FIG. 10C is diagram illustrating a process of manufacturing the printed circuit board subsequent to the process illustrated in FIG. 10B;

FIG. 10D is diagram illustrating a process of manufacturing the printed circuit board subsequent to the process illustrated in FIG. 10C;

FIG. 10E is diagram illustrating a process of manufacturing the printed circuit board subsequent to the process illustrated in FIG. 10D; and

FIG. 10F is diagram illustrating a process of manufacturing the printed circuit board subsequent to the process illustrated in FIG. 10E.

### DETAILED DESCRIPTION

Next, a comparative example is described only for understanding the following embodiments. In a transformer according to the comparative example, one coil is configured by connecting patterns of one or more wiring layers, and another coil is configured by connecting patterns of another one or more wiring layers.

In a printed circuit board of the transformer, an insulating layer is sandwiched between adjacent wiring layers. In the transformer, a voltage difference arises between the two coils. The insulating layer sandwiched between the wiring layer in which one coil is formed and the wiring layer in which the other coil is formed is required to have an insulating strength capable of withstanding the voltage difference between the coils. The thickness of the insulating layer needs to be increased with increase in the voltage difference between the coils. When the thickness of the insulating layer is large, the thickness of the printed circuit board in which the transformer is formed increases.

A transformer according to an aspect of the present disclosure includes a printed circuit board and a core. The printed circuit board includes wiring layers stacked in a stacking direction and an insulating layer sandwiched between adjacent wiring layers in the wiring layers. The core penetrates the printed circuit board. Each of the wiring layers includes a first winding pattern and a second winding pattern arranged to surround the core, and the first winding pattern and the second winding pattern in each of the wiring layers are insulated from each other. The first winding patterns of the adjacent wiring layers are connected by a first via disposed in the insulating layer, and the first winding patterns of the wiring layers are connected in series to constitute a first coil that surrounds the core. The second winding patterns of the adjacent wiring layers are connected by a second via disposed in the insulating layer, and the second winding patterns of the wiring layers are connected in series to constitute a second coil that surrounds the core.

In the transformer, the first winding patterns of the wiring layers constitute the first coil, and the second winding patterns of the same wiring layers constitute the second coil. The two coils are insulated by a distance between the winding patterns in each of the wiring layers. The thickness of the insulating layer does not contribute to the insulation between the two coils. Therefore, an increase in the thickness of the printed circuit board can be restricted.

In the transformer, the two coils may be arranged concentrically around the core in a plane parallel to the wiring layers. This configuration reduces leakage flux. That is, the transformer having this configuration has high power transmission efficiency.

Transformers may include three coils. The technique in the present disclosure is applicable to a transformer including three coils. In one aspect of the transformer disclosed herein, each of the wiring layers includes a third winding pattern surrounding the core. The third winding patterns of the adjacent wiring layers are connected by a third via disposed in the insulating layer. The third winding patterns of the wiring layers are connected in series to constitute a third coil that surrounds the core. In each of the wiring layers, the second winding pattern and the third winding pattern sandwich the first winding pattern. The second coil and the third coil are connected in parallel or in series. The second coil and the third coil connected in parallel or in series are suitable as a secondary coil, and the first coil is suitable as a primary coil. In the configuration in which the three coils are concentrically arranged and the first coil is located between the second coil and the third coil, power transmission efficiency from the first coil to the second coil and the third coil is high.

The two coils may have different numbers of turns. In order to make the number of turns different, sub-wiring layers each including the first winding pattern and not including the second winding pattern may be arranged in the printed circuit board. The number of turns of the coil formed by the first winding patterns is larger than the number of turns of the coil formed by the second winding patterns. In this case, the sub-wiring layers may be distributed uniformly in the stacking direction in the printed circuit board. The two coils are arranged in a well-balanced manner in the stacking direction. In this configuration, power transmission efficiency is higher than that in a case where the two coils are arranged in an unbalanced manner.

The transformer may further include a base substrate that supports the printed circuit board. The base substrate has a hole into which the core is fitted, a first land connected to the first coil, and a second land connected to the second coil. By accommodating one end of the core in the hole of the base substrate, space efficiency is improved. The space efficiency is also improved by electrically connecting the coil and the base substrate via the land.

### First Embodiment

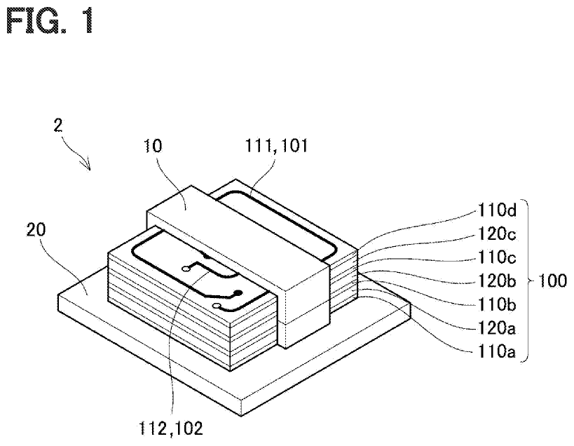

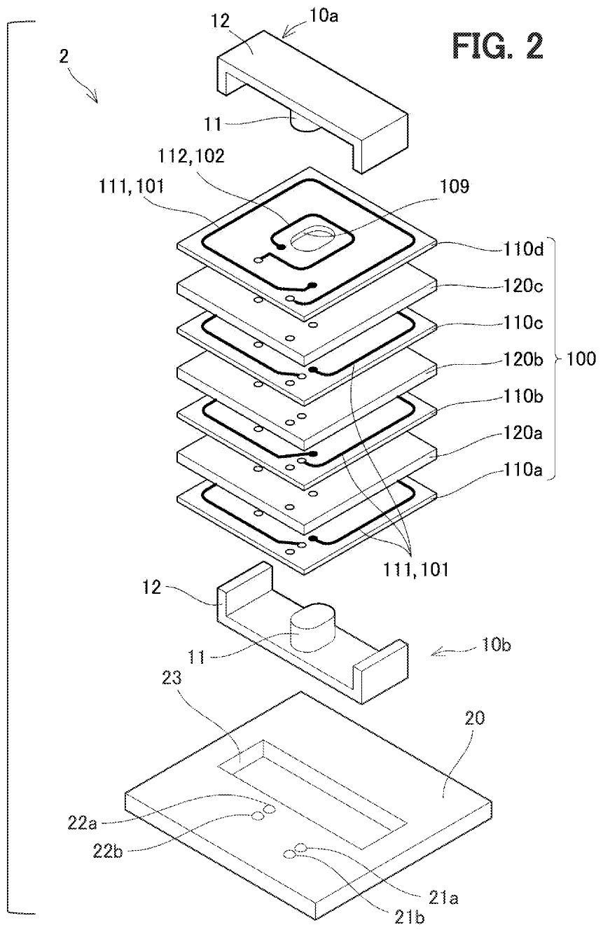

A transformer 2 according to a first embodiment will be described with reference to FIGS. 1 to 4. FIG. 1 is a perspective view of the transformer 2. The transformer 2 includes a printed circuit board 100, a core 10, and a base substrate 20. FIG. 2 is an exploded perspective view of the transformer 2. The printed circuit board 100 has a seven-layer structure. In FIG. 2, seven layers of the printed circuit board 100 are illustrated separately.

The core 10 is divided into an upper core 10a and a lower core 10b. The upper core 10a and the lower core 10b sandwich the printed circuit board 100. The core 10 includes a ring core 12 surrounding the printed circuit board 100, and rod cores 11 connected to two positions inside the ring core 12. The printed circuit board 100 has a through hole 109 through which the rod core 11 passes.

An assembly of the printed circuit board 100 and the core 10 is fixed to the base substrate 20. The base substrate 20 includes a hole 23, and a lower portion of the core 10 is fitted into the hole 23.

The printed circuit board 100 includes two coils, that is, a first coil 101 and a second coil 102. The configuration of the first coil 101 and the second coil 102 in the printed circuit board 100 will be described below.

The printed circuit board 100 includes first to fourth wiring layers 110a, 110b, 110c, and 110d and first to third insulating layers 120a, 120b, and 120c. The wiring layers 110a to 110d are stacked from bottom to top. The first insulating layer 120a is sandwiched between the adjacent wiring layers 110a and 110b. The second insulating layer 120b is sandwiched between the adjacent wiring layers 110b and 110c. The third insulating layer 120c is sandwiched between the adjacent wiring layers 110c and 110d. The “wiring layer” is a layer of a conductor pattern formed on a surface of an insulating substrate by etching or the like. A thick line drawn in each of the wiring layers 110a, 110b, 110c, and 110d represents a wiring pattern (winding pattern). The wiring layer is provided on an upper surface and a lower surface of the insulating substrate. The wiring layer may be referred to as a conductor layer or a conductor pattern layer.

The first insulating layer 120a and the third insulating layer 120c are insulating substrates, and the second insulating layer 120b is made of an insulating material called prepreg. The first wiring layer 110a is formed on a lower surface of the first insulating layer 120a, and the second wiring layer 110b is formed on an upper surface of the first insulating layer 120a. The third wiring layer 110c is formed on a lower surface of the third insulating layer 120c, and the fourth wiring layer 110d is formed on an upper surface of the third insulating layer 120c. The second insulating layer 120b is sandwiched between the second wiring layer 110b and the third wiring layer 110c. The insulating layers 120a and 120c and the insulating layer 120b are made of different materials, but have the same function (insulation between adjacent wiring layers).

Hereinafter, any one of the first to fourth wiring layers 110a, 110b, 110c, and 110d may be referred to as a wiring layer 110, and any one of the first to third insulating layers 120a, 120b, and 120c may be referred to as an insulating layer 120.

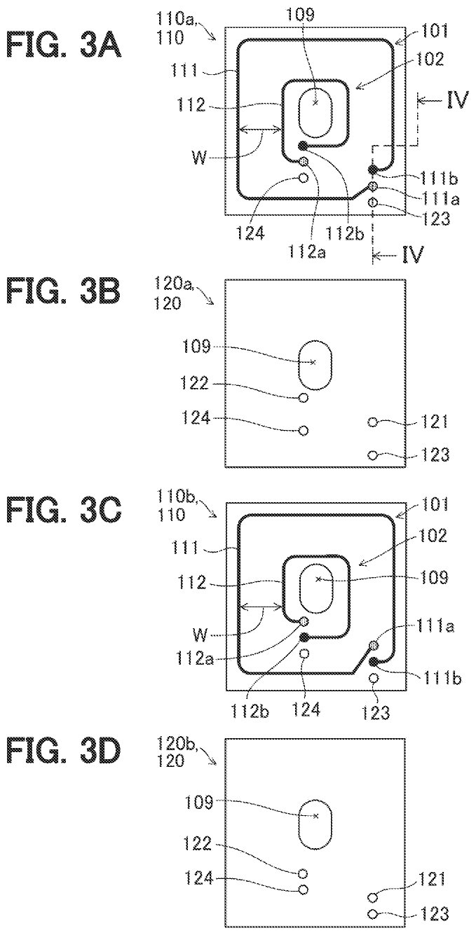

FIG. 3A is a plan view of the first wiring layer 110a, FIG. 3B is a plan view of the first insulating layer 120a, FIG. 3C is a plan view of the second wiring layer 110b, FIG. 3D is a plan view of the second insulating layer 120b, FIG. 3E is a plan view of the third wiring layer 110c, FIG. 3F is a plan view of the third insulating layer 120c, FIG. 3G is a plan view of the fourth insulating layer 110d. The first wiring layer 110a is located at the lowermost position, and the fourth wiring layer 110d is located at the uppermost position. Each of the wiring layers 110 and each of the insulating layers 120 have the through hole 109, and the rod core 11 is fitted into the through hole 109 as described above. Each of the insulating layers 120 has a first via 121 and a second via 122. The printed circuit board 100 has through vias 123 and 124 penetrating the all layers of the printed circuit board 100.

Each of the wiring layers 110 includes a first winding pattern 111 and a second winding pattern 112. The first winding pattern 111 and the second winding pattern 112 are insulated from each other in each of the wiring layers 110. Each of the first winding pattern 111 and the second winding pattern 112 is disposed so as to surround the through hole 109 (that is, the rod core 11).

For convenience of description, one end of the first winding pattern 111 is referred to as a start point 111a, and the other end of the first winding pattern 111 is referred to as an end point 111b. To facilitate understanding, in FIGS. 3A, 3C, 3E, and 3G, the start point 111a is indicated by a hatched circle, and the end point 111b is indicated by a black circle. In each of the wiring layers 110, the first winding pattern 111 surrounds the through hole 109 (that is, the rod core 11) clockwise from the start point 111a toward the end point 111b. The first winding patterns 111 of the wiring patterns adjacent to each other in the stacking direction are connected by the first via 121 provided in the insulating layer disposed between the first winding patterns 111. The start point 111a of the first winding pattern 111 of an upper one of the wiring layers 110 is located immediately above the ending point 111b of the first winding pattern 111 of a lower one of the wiring layers 110. The end point 111b of the first winding pattern 111 of the lower one of the wiring layer 110 is connected to the start point 111a of the first winding pattern 111 of the upper one of the wiring layer 110 by the first via 121.

The first winding patterns 111 are sequentially connected in series from the first wiring layer 110a to the fourth wiring layer 110d. The first winding patterns 111 constitute the first coil 101 that is wound clockwise around the rod core 11.

The same applies to the second winding patterns 112 of the four wiring layers 110, and the second winding patterns 112 are sequentially connected in series to constitute the second coil 102 that is wound clockwise around the rod core 11. The second winding patterns 112 adjacent to each other in the stacking direction are connected by the second via 122 of the insulating layer 120 disposed between the second winding patterns 112.

The first coil 101 and the second coil 102 surround the one rod core 11. For example, when an alternating current is applied to the first coil 101, an alternating current is generated in the second coil 102 via a magnetic field generated in the rod core 11. That is, the first coil 101 (that is, the first winding patterns 111), the second coil 102 (that is, the second winding patterns 112), and the core 10 constitute a transformer.

The first coil 101 and the second coil 102 are formed in the same wiring layers 110. Therefore, insulation between the first coil 101 and the second coil 102 is ensured by a distance W between the first winding pattern 111 and the second winding pattern 112. The thickness of the insulating layer 120 disposed between the adjacent wiring layers 110 does not affect the insulation performance between the first coil 101 and the second coil 102. The insulating layer 120 ensures insulation between adjacent windings of the coils. Since the voltage difference between adjacent windings of the coils is small, the insulation performance required for the insulating layers 120 is low. That is, since the transformer 2 does not require a thick insulating layer, the thickness of the printed circuit board 100 can be reduced. The thickness of each of the insulating layers 120 can be shorter than the distance W (see FIG. 3) between the first winding pattern 111 and the second winding pattern 112.

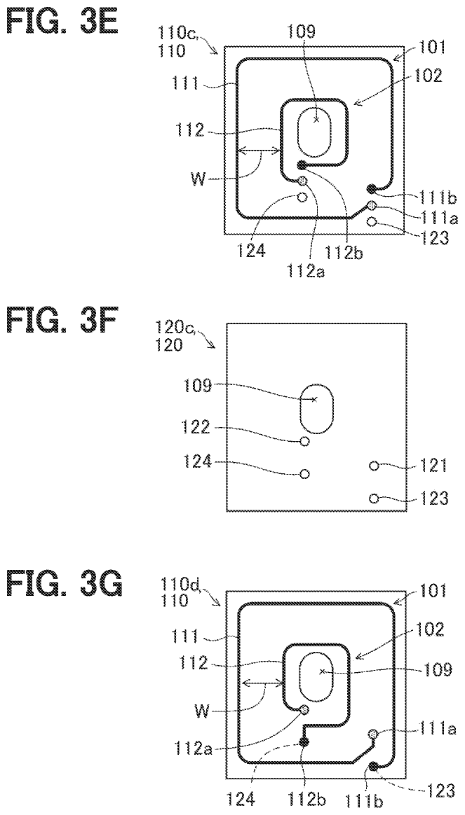

FIG. 4 shows a cross section of the transformer 2 corresponding to a cross section taken along line IV-IV in FIG. 3A. FIG. 4 shows a cross section passing through the start point 111a and the end point 111b of the first winding pattern 111 of each of the wiring layers 110.

As described above, the start point 111a of the first winding pattern 111 of the second wiring layer 110b is located immediately above the end point 111b of the first winding pattern 111 of the first wiring layer 110a. The end point 111b and the start point 111a are connected by the first via 121 of the first insulating layer 120a disposed between the first wiring layer 110a and the second wiring layer 110b. The start point 111a of the first winding pattern 111 of the third wiring layer 110c is located immediately above the end point 111b of the first winding pattern 111 of the second wiring layer 110b. The first winding pattern 111 of the second wiring layer 110b and the first winding pattern 111 of the third wiring layer 110c are connected by the first via 121 disposed in the second insulating layer 120b between the second wiring layer 110b and the third wiring layer 110c. The start point 111a of the first winding pattern 111 of the fourth wiring layer 110d is located immediately above the end point 111b of the first winding pattern 111 of the third wiring layer 110c. The first winding pattern 111 of the third wiring layer 110c and the first wiring pattern 111 of the fourth wiring layer 110d are connected by the first via 121 disposed in the third insulating layer 120c between the third wiring layer 110c and the fourth wiring layer 110d. As understood from FIG. 4, the position of the start point 111a of one wiring layer (for example, the first wiring layer 110a) may be different from the position of the start point 111a of another wiring layer (for example, the second wiring layer 110b). The same applies to the end points 111b.

The printed circuit board 100 is fixed on the base substrate 20. First lands 21a and 21b are provided on an upper surface of the base substrate 20. The start point 111a of the first winding pattern 111 of the first wiring layer 110a, which is the lowermost wiring layer, corresponds to the start point of the first coil 101. The start point of the first coil 101 (that is, the start point 111a of the first wiring layer 110a) is connected to the first land 21a of the base substrate 20.

The end point 111b of the first winding pattern 111 of the fourth wiring layer 110d, which is the uppermost wiring layer, corresponds to the end point of the first coil 101. A through via 123 penetrating from the top to the bottom of the printed circuit board 100 is located immediately below the end point 111b of the fourth wiring layer 110d. The end point of the first coil 101 (that is, the end point 111b of the fourth wiring layer 110d) is connected to the first land 21b of the base substrate 20 through the through via 123. The first lands 21a, 21b are respectively connected to conductive patterns 25a, 25b disposed on a lower surface of the base substrate 20 through vias 24a, 24b. The conductive patterns 25a and 25b are connected to a circuit (not shown). The circuit (not shown) uses the transformer 2.

Similarly to the start point and the end point of the first coil 101, a start point and an end point of the second coil 102 are connected to second lands 22a and 22b (see FIG. 2 and FIGS. 3A to 3G) provided on the base substrate 20. The start point of the second coil 102 is located in the first wiring layer 110a, which is the lowermost wiring layer, and is directly connected to the second land 22a. The end point of the second coil 102 is located in the fourth wiring layer 110d, which is the uppermost wiring layer, and is connected to the second land 22b via a through via 124 penetrating the printed circuit board 100.

Returning to FIGS. 1 and 2, another advantage of the transformer 2 will be described. The lower portion of the core 10 is fitted into the hole 23 of the base substrate 20. The first lands 21a, 21b and the second lands 22a, 22b are provided on the upper surface of the base substrate 20, and these lands are connected to the first coil 101 or the second coil 102. The circuit using the transformer 2 is mounted on the base substrate 20. With the above-described structure of the base substrate 20, the transformer 2 and the circuit can be compactly integrated.

### Second Embodiment

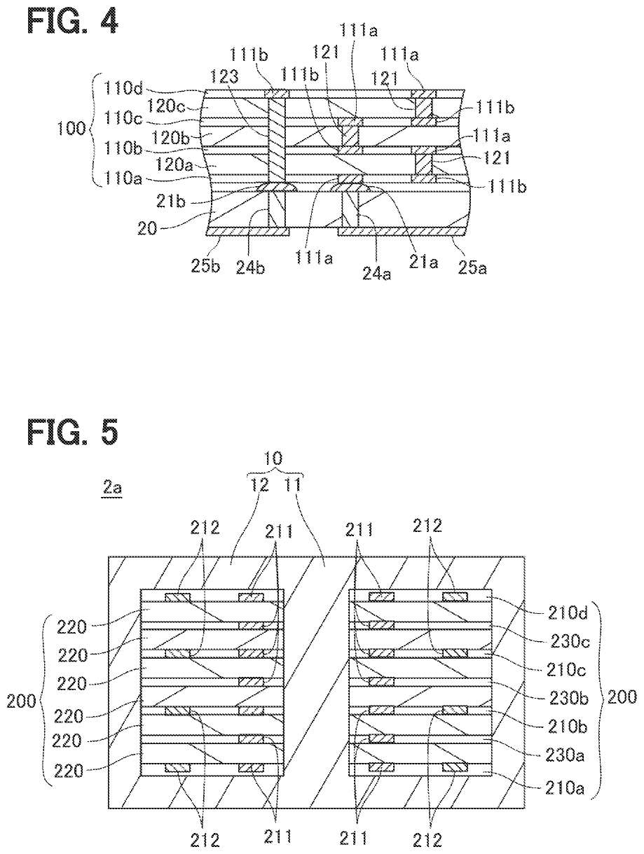

FIG. 5 is a cross-sectional view of a transformer 2a according to a second embodiment. FIG. 5 is a cross-sectional view of a printed circuit board 200 of the transformer 2a. The transformer 2a has a core 10. The core 10 includes a rod core 11 penetrating the printed circuit board 200 and a ring core 12 surrounding the printed circuit board 200. Both ends of the rod core 11 are connected to an inner peripheral surface of the ring core 12. The core 10 is the same as the core 10 of the transformer 2 of the first embodiment.

The printed circuit board 200 includes four wiring layers 210a to 210d, three sub-wiring layers 230a to 230c, and six insulating layers 220. These layers are stacked. One insulating layer is sandwiched between adjacent wiring layers.

The wiring layers 210a to 210d are the same as the wiring layers 110a to 110d of the first embodiment, and each wiring layer includes a first winding pattern 211 and a second winding pattern 212. The sub-wiring layers 230a to 230c include the first winding pattern 211 but do not include the second winding pattern 212. The sub-wiring layers 230a to 230c are distributed uniformly in the stacking direction.

The first winding patterns 211 adjacent to each other in the stacking direction are connected to each other, and the first winding patterns 211 connected in series constitute a first coil. The second winding patterns 212 adjacent to each other in the stacking direction are also connected to each other, and the second winding patterns 212 connected in series constitute a second coil. As is clear from FIG. 5, the number of the first winding patterns 211 is larger than the number of the second winding patterns 212. That is, the number of turns of the first coil is larger than the number of turns of the second coil. The sub-wiring layers 230 are distributed uniformly in the printed circuit board 200. Therefore, two coils, that is, the first coil and the second coil face each other in a well-balanced manner in the stacking direction. With such a structure, leakage flux between the two coils is restricted, and power transmission efficiency from one coil to the other coil is improved.

### Third Embodiment

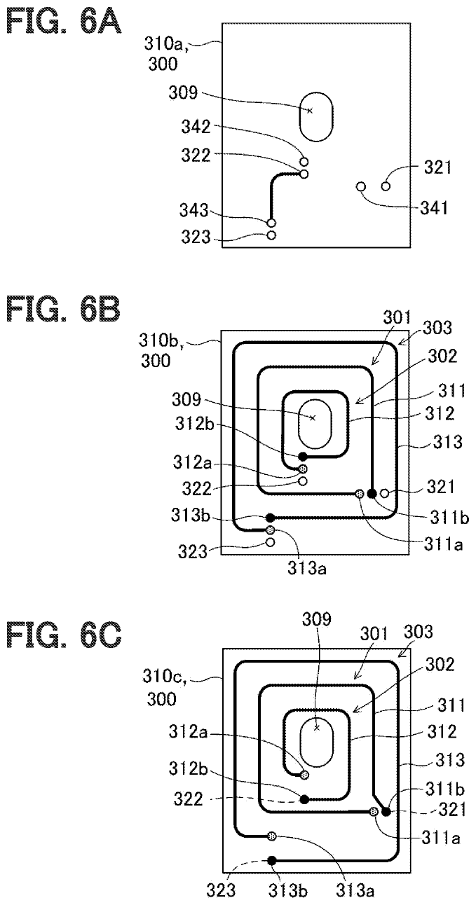

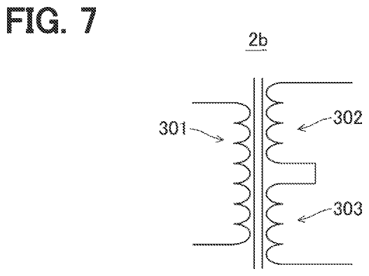

A transformer 2b according to a third embodiment will be described with reference to FIGS. 6A to 6C and FIG. 7. FIG. 6A is a plan view of a first wiring layer 310a in the transformer 2b, FIG. 6B is a plan view of a second wiring layer 310b in the transformer 2ba, and FIG. 6C is a plan view of a third wiring layer 310c in the transformer 2b. The wiring layers 310a to 310c are stacked with insulating layers interposed therebetween. The insulating layer is not shown. The first wiring layer 310a is the lowermost layer, and the third wiring layer 310c is the uppermost layer. Each of the wiring layers 310a to 310c has a through hole 309, and a core (not shown) is inserted into the through hole 309.

Each of the wiring layers 310b and 310c has a first winding pattern 311, a second winding pattern 312, and a third winding pattern 313 so as to surround the through hole 309 and the core. As in the first embodiment, a start point 311a of the first winding pattern 311 is indicated by a hatched circle, and an end point 311b is indicated by a black circle. The same applies to a start point 312a and an end point 312b of the second winding pattern 312. The same applies to a start point 313a and an end point 313b of the third winding pattern 313.

In each wiring layer, the winding patterns 311, 312, and 313 are insulated from each other. The first winding patterns 311 adjacent to each other in the stacking direction are connected to each other, and the first winding patterns 311 connected in series constitute a first coil 301 surrounding the through hole 309 and the core. The second winding patterns 312 adjacent to each other in the stacking direction are connected to each other, and the second winding patterns 312 connected in series constitute a second coil 302 surrounding the through hole 309 and the core. The third winding patterns 313 adjacent to each other in the stacking direction are connected to each other, and the third winding patterns 313 connected in series constitute a third coil 303 surrounding the through hole 309 and the core. In each wiring layer 310, the second winding pattern 312 and the third winding pattern 313 sandwich the first winding pattern 311. That is, the first coil 301 is located between the second coil 302 and the third coil 303.

The printed circuit board 300 has first to third through vias 321, 322, and 323 penetrating the printed circuit board 300 from top to bottom. The first wiring layer 310a, which is the lowermost wiring layer, has terminals 341, 342, and 343. The terminal 341 is connected to the start point 311a of the first winding pattern 311 of the second wiring layer 310b. An upper end of the first through via 321 is connected to the end point 311b of the first winding pattern 311 in the third wiring layer 310c, which is the uppermost wiring layer. That is, the terminal 341 and the first through via 321 correspond to a start point and an end point of the first coil 301.

The terminal 342 is connected to the start point 312a of the second winding pattern 312 of the second wiring layer 310b. An upper end of the second through via 322 is connected to the end point 312b of the second winding pattern 312 in the third wiring layer 310c, which is the uppermost wiring layer. That is, the terminal 342 and the second through via 322 correspond to a start point and an end point of the second coil 302. The terminal 343 is connected to the start point 313a of the third winding pattern 313 of the wiring layer 310b. The upper end of the third through via 323 is connected to the end point 313b of the third winding pattern 313 in the third wiring layer 310c, which is the uppermost wiring layer. That is, the terminal 343 and the third through via 323 correspond to a start point and an end point of the third coil 303.

The second through via 322 and the terminal 343 are connected to each other in the first wiring layer 310a, which is the lowermost wiring layer. That is, the second coil 302 and the third coil 303 are connected in series. FIG. 7 is a circuit diagram of the transformer 2b. The second coil 302 and the third coil 303 are connected in series, and the first coil 301 is insulated from the second coil 302 and the third coil 303. As shown in FIG. 7, the first coil 301 is suitable as a primary coil, and the second coil 302 and the third coil 303 are suitable as secondary coils. As shown in FIGS. 6A to 6C, the second coil 302 and the third coil 303 are adjacent to the inside and the outside of the first coil 301, respectively. Electric power is equally transmitted from the first coil 301 to each of the second coil 302 and the third coil 303. The transformer 2b has high power transmission efficiency from the primary coil (that is first coil 301) to the secondary coils (that is, the second coil 302 and the third coil 303).

### Fourth Embodiment

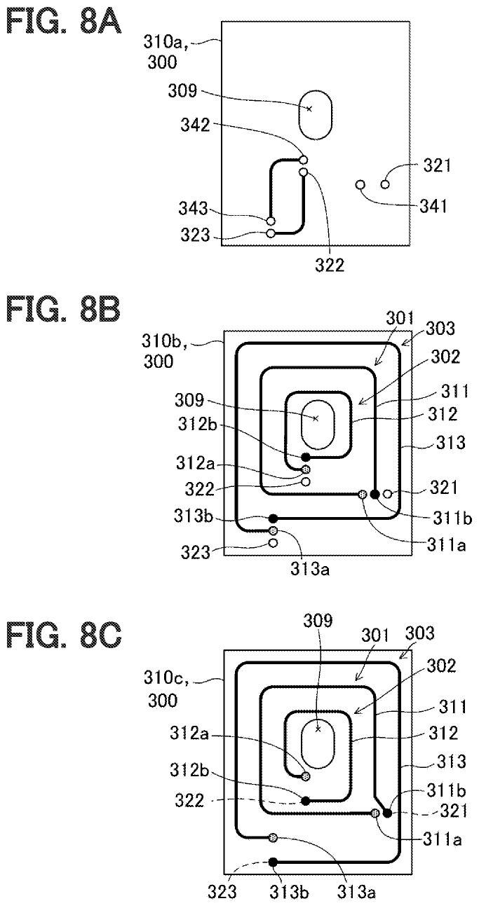

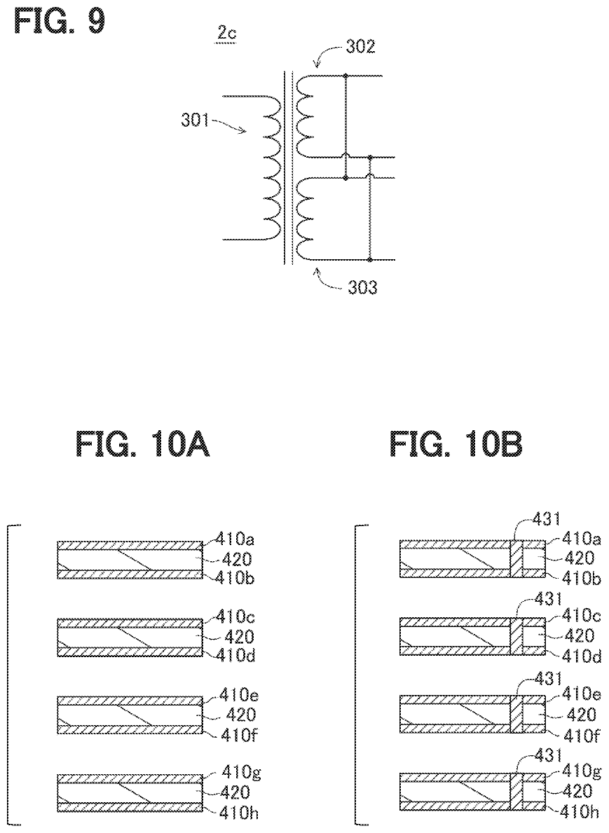

A transformer 2c of a fourth embodiment will be described with reference to FIGS. 8A to 8C and FIG. 9. FIG. 8A is a plan view of a first wiring layer 310a in a printed circuit board 300 in the transformer 2c, FIG. 8B is a plan view of a second wiring layer 310b, and FIG. 8C is a plan view of a third wiring layer 310c. The transformer 2c of the fourth embodiment is different from the transformer 2b of the third embodiment in the connection relationship between the second coil 302 and the third coil 303, but the other configuration is the same as the configuration of the transformer 2b. That is, the connection relationship between the second through via 322, the third through via 323, and the terminals 342 and 343 is different from that of the transformer 2b of the third embodiment. As illustrated in FIGS. 8A to 8C, the second through via 322 and the third through via 323 are connected to each other, and the terminal 342 and the terminal 343 are connected to each other. As described above, the terminal 342 corresponds to the start point of the second coil 302, and the terminal 343 corresponds to the start point of the third coil 303. The second through via 322 corresponds to the end point of the second coil 302, and the third through via 323 corresponds to the end point of the third coil 303. That is, in the transformer 2c of the fourth embodiment, the second coil 302 and the third coil 303 are connected in parallel. FIG. 9 is a circuit diagram of the transformer 2c. Similarly to the transformer 2b of the third embodiment, also in the transformer 2c of the fourth embodiment, the second coil 302 and the third coil 303 are adjacent to the inside and the outside of the first coil 301, respectively. Electric power is equally transmitted from the first coil 301 to each of the second coil 302 and the third coil 303. This transformer 2c also has high power transmission efficiency from the primary coil (that is, the first coil 301) to the secondary coils (that is, the second coil 302 and the third coil 303).

### (Manufacturing Method)

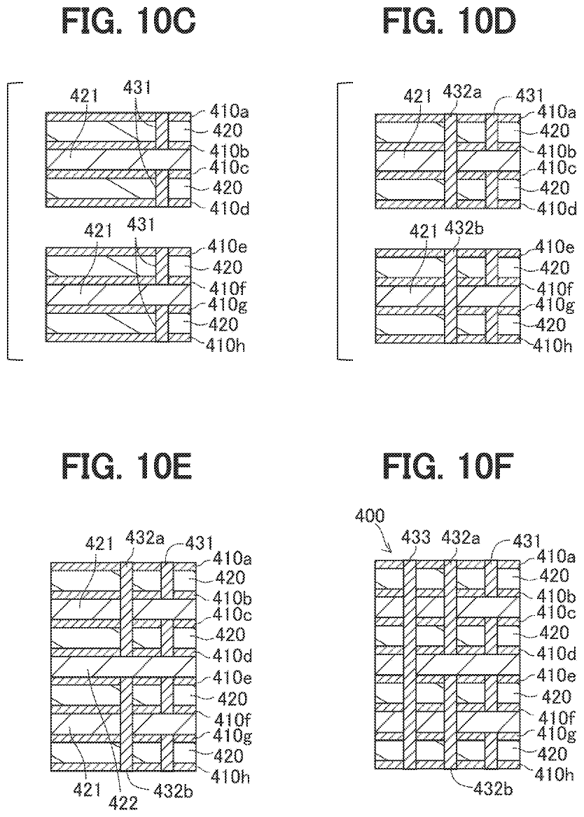

A preferred method of manufacturing a printed circuit board 400 of a transformer according to an embodiment will be described with reference to FIGS. 10A to 10F. The printed circuit board 400 includes eight wiring layers 410a to 410h and insulating layers 420, 421, and 422. Each of insulating layers 420, 421 and 422 is sandwiched between adjacent wiring layers. In FIGS. 10A to 10F, the wiring layers are represented by hatched rectangles, and illustration of winding patterns is omitted.

First, as shown in FIG. 10A, the wiring layers 410a, 410c, 410e, and 410g including winding patterns are formed on respective upper surfaces of four insulating layers 420, and wiring layers 410b, 410d, 410f, and 410h including winding patterns are formed on respective lower surfaces of the four insulating layers 420. The four insulating layers 420 are insulating substrates.

Subsequently, as shown in FIG. 10B, a via 431 that connects the winding patterns of the upper and lower wiring layers is formed in each of the insulating layers 420. Next, as shown in FIG. 10C, the insulating layer 420 on which the wiring layers 410a and 410b are formed and the insulating layer 420 on which the wiring layers 410c and 410d are formed are pressure-bonded with another insulating layer 421 interposed therebetween. Similarly, as shown in FIG. 10C, the insulating layer 420 on which the wiring layers 410e and 410f are formed and the insulating layer 420 on which the wiring layers 410g and 410h are formed are pressure-bonded with another insulating layer 421 interposed therebetween. The insulating layer 421 is made of an insulating material called prepreg.

Next, as shown in FIG. 10D, a via 432a that connects the winding patterns of the wiring layer 410c and the wiring layer 410d is formed. The via 432a penetrates the wiring layers 410a to 410d. In the wiring layers 410a and 410d, the winding patterns are formed so as to avoid the via 432a. In the wiring layers 410b and 410c, the winding patterns are formed so that ends of the winding patterns are in contact with the via 432a. A via 432b is similarly formed in the stacked body from the wiring layer 410e to the wiring layer 410h. The via 432b connects the winding patterns of the wiring layers 410f and 410g. In the wiring layers 410e and 410h, the winding patterns are formed so as to avoid the via 432b.

Subsequently, as shown in FIG. 10E, the stacked body of the wiring layers 410a to 410d and the stacked body of the wiring layers 410e to 410h are pressure-bonded with the insulating layer 422 interposed therebetween. Finally, as shown in FIG. 10F, a via 433 penetrating the printed circuit board 400 from the wiring layer 410a to the wiring layer 410h is formed. In the wiring layers 410d and 410e, the winding patterns are formed so that ends of the winding patterns are in contact with the via 433. In the wiring layers 410a to 410c and 410f to 410h, the winding patterns are formed so as to avoid the via 433.

As a result of the above processes, the winding patterns of the wiring layers 410a and 410b are connected by the shortest via 431, and the winding patterns of the wiring layers 410b and 410c are connected by the via 432a. The winding patterns of the wiring layers 410c and 410d are connected by another via 431. The winding patterns of the wiring layers 410d and 410e are connected by the longest via 433. The winding patterns of the wiring layers 410e-410h are connected in the same manner. The winding patterns of the eight wiring layers 410a to 410h are connected in series as described above. The shortest via 431 is preferably thinner than the other vias 432a, 432b, and 433. The longest via 433 is preferably thicker than the other vias 431, 432a, and 432b. However, the thickness of the via may be determined by other factors. The positions of the vias may be determined so that as many vias as possible overlap in the stacking direction of the wiring layers.

Points to be noted regarding the technique described in the above-described embodiments will be described. The winding pattern of each of the wiring layers may be formed so as to make one round around the core, or may be formed so as to surround the core a plurality of times. Alternatively, the winding pattern may be formed so as to surround a part of the core. The winding patterns of the wiring layers are slightly different in shape from each other. The start point of one of the adjacent winding patterns and the end point of the other of the adjacent winding patterns are arranged to overlap each other in the stacking direction. However, the remaining end points and start points are arranged so as not to overlap in the stacking direction.

The first winding patterns are connected in series so as to turn around the core in one direction. In other words, the first winding patterns are connected in series so as to surround the core, and constitute the first coil. The second winding patterns or the third winding patterns are similarly connected.

As described above, the insulation between the two coils is ensured by the distance between the winding patterns and does not depend on the thickness of the insulating layer. The thickness of the insulating layer may be shorter than the distance W between the first winding pattern and the second winding pattern in each of the wiring layers.

Although specific examples of the present disclosure have been described in detail above, these are merely examples and do not limit the scope of claims. The techniques described in the present description include various modifications of the specific examples illustrated above. The technical elements described in the present description or the drawings exhibit technical usefulness alone or in various combinations, and are not limited to the combinations described in the present description at the time of filing. In addition, the techniques illustrated in the present specification or drawings can achieve multiple purposes at the same time, and achieving one of the purposes itself has technical usefulness.

What is claimed is:

1. A transformer comprising:
a printed circuit board including wiring layers stacked in a stacking direction and an insulating layer sandwiched between adjacent wiring layers in the wiring layers; and
a core penetrating the printed circuit board, wherein
each of the wiring layers includes a first winding pattern and a second winding pattern arranged to surround the core, and the first winding pattern and the second winding pattern in each of the wiring layers are insulated from each other,
the first winding patterns of the adjacent wiring layers are connected by a first via disposed in the insulating layer, and the first winding patterns of the wiring layers are connected in series to constitute a first coil that surrounds the core, and
the second winding patterns of the adjacent wiring layers are connected by a second via disposed in the insulating layer, and the second winding patterns of the wiring layers are connected in series to constitute a second coil that surrounds the core.

2. The transformer according to claim 1, wherein
the first winding pattern of each of the wiring layers has a start point and an end point, and
the end point of the first winding pattern of one of the adjacent wiring layers and the start point of the first winding pattern of another of the adjacent wiring layers overlap each other in the stacking direction and are connected to each other by the first via.

3. The transformer according to claim 1, wherein
each of the wiring layers further includes a third winding pattern surrounding the core,
the third winding patterns of the adjacent wiring layers are connected by a third via disposed in the insulating layer, and the third winding patterns of the wiring layers are connected in series to constitute a third coil that surrounds the core,
in each of the wiring layers, the second winding pattern and the third winding pattern sandwich the first winding pattern, and
the second coil and the third coil are connected in parallel or in series.

4. The transformer according to claim 1, wherein
the printed circuit board further includes sub-wiring layers each including the first winding pattern but not including the second winding pattern, and
the sub-wiring layers are distributed uniformly in the stacking direction in the printed circuit board.

5. The transformer according to claim 1, further comprising
a base substrate supporting the printed circuit board, wherein
the base substrate has a hole into which the core is fitted, a first land connected to the first coil, and a second land connected to the second coil.
